(19) United States
(12) Patent Application Publication
(10) Pub. No.: US 2026/0351196 A1
(43) Pub. Date: Nov. 5, 2026

(54) DISPLAY DEVICE AND ELECTRONIC DEVICE INCLUDING THE SAME

(71) Applicant: Samsung Display Co., LTD., Yongin-si (KR)

(72) Inventors: Seungha Baek, Yongin-si (KR); Taehun Lee, Yongin-si (KR); SANGHYUN HEO, Yongin-si (KR); OHJO KWON, Yongin-si (KR)

(21) Appl. No.: 19/655,875

(22) Filed: Apr. 23, 2026

(30) Foreign Application Priority Data
Apr. 30, 2025 (KR) 10-2025-0057380
Feb. 19, 2026 (KR) 10-2026-0031192

(51) Int. Cl. G09G 3/3266; G09G 3/3275

(52) U.S. Cl. CPC G09G 3/3266; G09G 3/3275; G09G 2300/043; G09G 2300/0819; G09G 2320/0233; G09G 2320/066

(57) ABSTRACT

A display device includes a first transistor including a gate connected to a first node, a first terminal for receiving a first power voltage, and a second terminal connected to a second node, a second transistor for transmitting a data signal to a third node in response to a write gate signal, a first capacitor connected between the first node and the third node, a third transistor for connecting the first node to the second node, a fourth transistor including a gate, a first terminal connected to the second node, and a second terminal connected to a fourth node, and a light-emitting element including a first terminal connected to the fourth node, and a second terminal for receiving a second power voltage. An activation voltage level of a signal received by the gate of the fourth transistor is different from an activation voltage level of the write gate signal.

This application claims priority to Korean Patent Application No. 10-2025-0057380, filed on Apr. 30, 2025 and Korean Patent Application No. 10-2026-0031192, filed on Feb. 19, 2026, and all the benefits accruing therefrom under 35 U.S.C. § 119, the content of which in their entirety are herein incorporated by reference.

### BACKGROUND

### 1. Field

Embodiments relate to a display device. More particularly, embodiments relate to a display device including a pixel that emits light and an electronic device including a display device that displays an image.

### 2. Description of the Related Art

A display device may include a display panel, a gate driver, and a data driver. The display panel may include a pixel, the gate driver may provide gate signals to the pixel, and the data driver may provide a data voltage to the pixel.

The pixel may include a light-emitting element that emits light with a luminance corresponding to a driving current and a plurality of transistors including a driving transistor that generates the driving current. Based on the gate signals and the data voltage provided to the pixel, the driving transistor may be initialized, a threshold voltage of the driving transistor may be compensated, the data voltage may be written to the driving transistor, the light-emitting element may be initialized, and the light-emitting element may emit light.

### SUMMARY

Embodiments provide a display device with an improved display quality and an electronic device including the display device.

A display device according to embodiments includes a display panel including pixels, a gate driver to provide a write gate signal and a compensation gate signal to each of the pixels, an emission driver to provide an emission signal to each of the pixels, and a data driver to provide a data signal to each of the pixels. Each of the pixels includes a first transistor including a gate connected to a first node, a first terminal to receive a first power voltage, and a second terminal connected to a second node, a second transistor to transmit the data signal to a third node in response to the write gate signal, a first capacitor connected between the first node and the third node, a third transistor to connect the first node to the second node in response to the compensation gate signal, a fourth transistor including a gate, a first terminal connected to the second node, and a second terminal connected to a fourth node, and a light-emitting element including a first terminal connected to the fourth node, and a second terminal to receive a second power voltage. An activation voltage level of a signal received by the gate of the fourth transistor is different from an activation voltage level of the write gate signal.

In an embodiment, a difference between the activation voltage level and a deactivation voltage level of the signal received by the gate of the fourth transistor may be less than a difference between the activation voltage level and a deactivation voltage level of the write gate signal.

In an embodiment, the activation voltage level of the signal received by the gate of the fourth transistor may be higher than the activation voltage level of the write gate signal.

In an embodiment, the activation voltage level of the signal received by the gate of the fourth transistor in an initialization period in which the gate of the first transistor is initialized may be different from the activation voltage level of the signal received by the gate of the fourth transistor in an emission period in which the light-emitting element emits light.

In an embodiment, a difference between the activation voltage level and a deactivation voltage level of the signal received by the gate of the fourth transistor in the initialization period may be greater than a difference between the activation voltage level and the deactivation voltage level of the signal received by the gate of the fourth transistor in the emission period.

In an embodiment, the activation voltage level of the signal received by the gate of the fourth transistor in the initialization period may be lower than the activation voltage level of the signal received by the gate of the fourth transistor in the emission period.

In an embodiment, a type of the first transistor is the same as a type of the fourth transistor.

In an embodiment, each of the pixels may further include a second capacitor connected between the first node and a power line to transmit the first power voltage.

In an embodiment, each of the pixels may further include a fifth transistor to transmit a ground voltage to the fourth node in response to a bypass gate signal.

In an embodiment, the emission signal includes first and second emission signals, the gate of the fourth transistor receives the first emission signal, and each of the pixels may further include a sixth transistor to transmit the first power voltage to the first terminal of the first transistor in response to the second emission signal.

In an embodiment, the gate of the fourth transistor may receive the emission signal.

In an embodiment, the pixels may include a red pixel, a green pixel, and a blue pixel. An activation voltage level of a red emission signal received by the gate of the fourth transistor of the red pixel, an activation voltage level of a green emission signal received by the gate of the fourth transistor of the green pixel, and an activation voltage level of a blue emission signal received by the gate of the fourth transistor of the blue pixel may be different from each other.

In an embodiment, the fourth transistor may include a fourth-first transistor including a gate to receive a bias voltage, a first terminal connected to the second node and a second terminal, and a fourth-second transistor including a gate to receive the emission signal, a first terminal connected to the second terminal of the fourth-first transistor, and a second terminal connected to the fourth node.

In an embodiment, the emission signal may include first to third emission signals, and each of the pixels may further include a seventh-first transistor including a gate to receive the first emission signal, a first terminal to receive a first bias voltage and a second terminal connected to the gate of the fourth transistor, a seventh-second transistor including a gate to receive the second emission signal, a first terminal to receive a second bias voltage and a second terminal connected to the gate of the fourth transistor, and a seventh-third transistor including a gate to receive the third emission signal, a first terminal to receive a third bias voltage and a second terminal connected to the gate of the fourth transistor.

In an embodiment, each of the pixels may further include a seventh transistor including a gate to receive the emission signal, a first terminal connected to the first node, the third node or the fourth node, and a second terminal connected to the gate of the fourth transistor.

A display device according to embodiments includes a display panel including pixels, a gate driver to provide a write gate signal to each of the pixels, an emission driver to provide a first emission signal and a second emission signal to each of the pixels, and a data driver to provide a data signal to each of the pixels. Each of the pixels includes a first transistor including a gate connected to a first node, a first terminal connected to a second node, and a second terminal connected to a third node, a second transistor to transmit the data signal to the first node in response to the write gate signal, a first capacitor connected between the first node and the second node, a fourth transistor to connect the fourth node to a fourth node in response to the first emission signal, a sixth transistor to transmit a first power voltage to the second node in response to the second emission signal, and a light-emitting element including a first terminal connected to the fourth node, and a second terminal to receive a second power voltage. An activation voltage level of the first emission signal is different from an activation voltage level of the write gate signal.

In an embodiment, a difference between the activation voltage level and a deactivation voltage level of the first emission signal may be less than a difference between the activation voltage level and a deactivation voltage level of the write gate signal.

In an embodiment, the activation voltage level of the first emission signal may be higher than the activation voltage level of the write gate signal.

In an embodiment, each of the pixels may further include a second capacitor connected between the second node and a power line to transmit the first power voltage, and a fifth transistor to transmit a ground voltage to the fourth node in response to a bypass gate signal.

An electronic device according to embodiments includes a processor to generate input image data, a display device to display an image based on the input image data, and a power module connected to the processor and the display device. The display device includes a display panel including pixels, a gate driver to provide a write gate signal and a compensation gate signal to each of the pixels, an emission driver to provide an emission signal to each of the pixels, and a data driver to provide a data signal to each of the pixels. Each of the pixels includes a first transistor including a gate connected to a first node, a first terminal to receive a first power voltage, and a second terminal connected to a second node, a second transistor to transmit the data signal to a third node in response to the write gate signal, a first capacitor connected between the first node and the third node, a third transistor to connect the first node to the second node in response to the compensation gate signal, a fourth transistor including a gate, a first terminal connected to the second node, and a second terminal connected to a fourth node, and a light-emitting element including a first terminal connected to the fourth node, and a second terminal to receive a second power voltage. An activation voltage level of a signal received by the gate of the fourth transistor is different from an activation voltage level of the write gate signal.

In the pixel according to the embodiments, the activation voltage level of the signal received by the gate of the fourth transistor is different from (higher than) the activation voltage level of the write gate signal, so that a short-circuit path current flowing through the first transistor in the initialization period may decrease. Accordingly, a threshold voltage of the first transistor may be accurately compensated, and a block luminance of the light-emitting element may decrease.

In the display device and the electronic device according to the embodiments, a quality of an image displayed by the display device may be improved.

### BRIEF DESCRIPTION OF THE DRAWINGS

Illustrative, non-limiting embodiments will be more clearly understood from the following detailed description taken in conjunction with the accompanying drawings.

FIG. 1 is a block diagram illustrating a display device according to an embodiment.

FIG. 2 is a circuit diagram illustrating an example of a pixel of FIG. 1.

FIG. 3 is a timing diagram illustrating signals of FIG. 2.

FIG. 4 is a diagram for describing an initialization period of FIG. 3.

FIG. 5 is a diagram for describing a compensation period of FIG. 3.

FIG. 6 is a diagram for describing a writing period of FIG. 3.

FIG. 7 is a diagram for describing a bypass period of FIG. 3.

FIG. 8 is a diagram for describing an emission period of FIG. 3.

FIG. 9 is a timing diagram illustrating an emission signal according to the prior art.

FIG. 10 is a timing diagram illustrating an emission signal, a voltage of a first node, and a short-circuit path current in the initialization period.

FIG. 11 is a block diagram illustrating a display device according to an embodiment.

FIG. 12 is a circuit diagram illustrating an example of a pixel of FIG. 11.

FIG. 13 is a timing diagram illustrating signals of FIG. 12.

FIG. 14 is a block diagram illustrating a display device according to an embodiment.

FIG. 15 is a circuit diagram illustrating an example of a pixel of FIG. 14.

FIG. 16 is a timing diagram illustrating signals of FIG. 15.

FIG. 17 is a block diagram illustrating a display device according to an embodiment.

FIG. 18 is a circuit diagram illustrating an example of pixels of FIG. 17.

FIG. 19 is a timing diagram illustrating signals of FIG. 18.

FIG. 20 is a circuit diagram illustrating an example of the pixel of FIG. 1.

FIG. 21 is a timing diagram illustrating signals of FIG. 20.

FIG. 22 is a block diagram illustrating a display device according to an embodiment.

FIG. 23 is a circuit diagram illustrating an example of a pixel of FIG. 22.

FIG. 24 is a timing diagram illustrating signals of FIG. 23.

FIG. 25 is a circuit diagram illustrating an example of the pixel of FIG. 1.

FIG. 26 is a timing diagram illustrating a signal of FIG. 25.

FIG. 27 is a block diagram illustrating an electronic device according to an embodiment.

FIG. 28 is a diagram illustrating electronic devices according to embodiments.

### DETAILED DESCRIPTION

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

It will be understood that, although the terms “first,” “second,” “third”, “fourth-first”, “fourth-second”, “seventh-first”, “seventh-second”, “seventh-third”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Hereinafter, a display device and an electronic device according to embodiments of the present disclosure will be described in more detail with reference to the accompanying drawings. The same or similar reference numerals will be used for the same elements in the accompanying drawings.

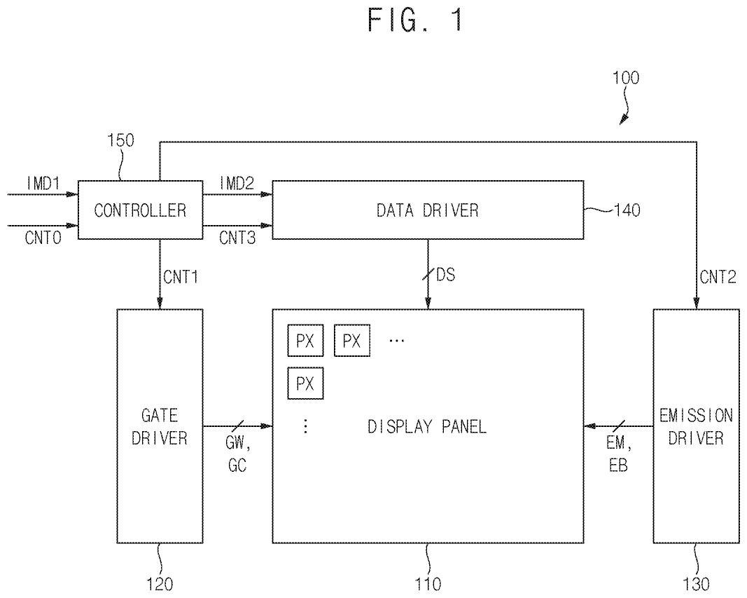

FIG. 1 is a block diagram illustrating a display device 100 according to an embodiment.

Referring to FIG. 1, the display device 100 may include a display panel 110, a gate driver 120, an emission driver 130, a data driver 140, and a controller 150.

The display panel 110 may include pixels PX. Each of the pixels PX may emit light based on a write gate signal GW, a compensation gate signal GC, an emission signal EM, a bypass gate signal EB, and a data signal DS.

The gate driver 120 may provide the write gate signal GW and the compensation gate signal GC to each of the pixels PX. The gate driver 120 may generate the write gate signal GW and the compensation gate signal GC on a pixel row basis. The gate driver 120 may generate the write gate signal GW and the compensation gate signal GC based on a first control signal CNT1. The first control signal CNT1 may include a write gate start signal, a compensation gate start signal, gate clock signals, etc.

The emission driver 130 may provide the emission signal EM and the bypass gate signal EB to each of the pixels PX. The emission driver 130 may generate the emission signal EM and the bypass gate signal EB on a pixel row basis. The emission driver 130 may generate the emission signal EM and the bypass gate signal EB based on a second control signal CNT2. The second control signal CNT2 may include an emission start signal, a bypass gate start signal, emission clock signals, etc.

In an embodiment, as illustrated in FIG. 1, the bypass gate signal EB may be generated by the emission driver 130. In an embodiment, the bypass gate signal EB may be generated by the gate driver 120.

The data driver 140 may provide the data signal DS to each of the pixels PX. The data driver 140 may generate the data signal DS based on output image data IMD2 and a third control signal CNT3. The data driver 140 may convert the digital output image data IMD2 into the analog data signal DS. The third control signal CNT3 may include a load signal, a data clock signal, an output data enable signal, etc.

The controller 150 may control the gate driver 120, the emission driver 130, and the data driver 140. The controller 150 may provide the first control signal CNT1 to the gate driver 120, may provide the second control signal CNT2 to the emission driver 130, and may provide the output image data IMD2 and the third control signal CNT3 to the data driver 140. The controller 150 may generate the output image data IMD2, the first control signal CNT1, the second control signal CNT2, and the third control signal CNT3 based on input image data IMD1 and a control signal CNT0. In an embodiment, the input image data IMD1 may include red image data, green image data, and blue image data. The control signal CNT0 may include a vertical synchronization signal, a horizontal synchronization signal, a master clock signal, an input data enable signal, etc.

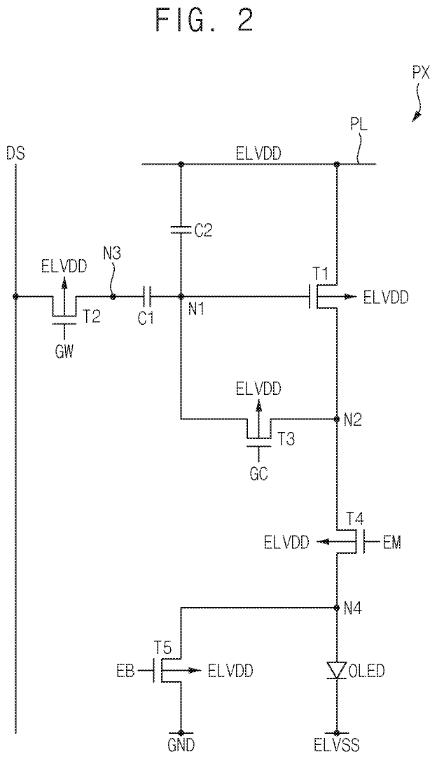

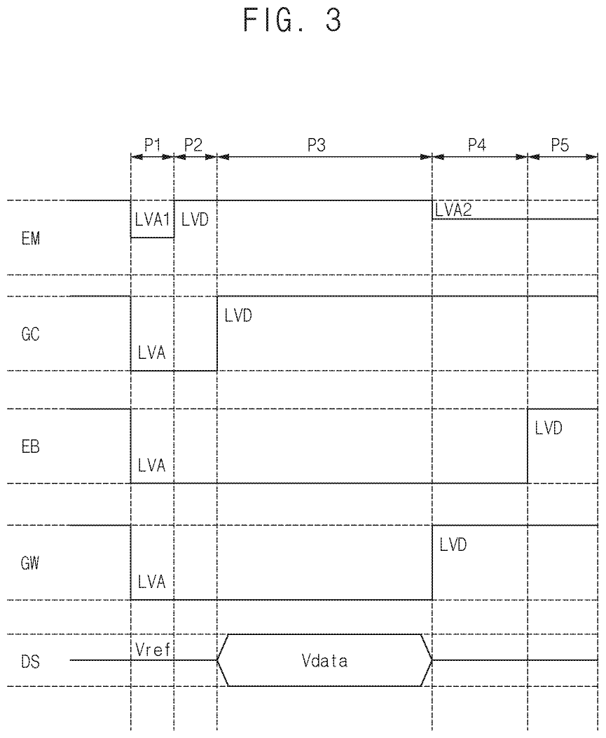

FIG. 2 is a circuit diagram illustrating an example of the pixel PX of FIG. 1. FIG. 3 is a timing diagram illustrating the signals EM, GC, EB, GW, and DS of FIG. 2.

Referring to FIGS. 2 and 3, the pixel PX may include a first transistor T1, a second transistor T2, a first capacitor C1, a second capacitor C2, a third transistor T3, a fourth transistor T4, a fifth transistor T5, and a light-emitting element OLED.

The first transistor T1 may include a gate connected to a first node N1, a first terminal that receives a first power voltage ELVDD, and a second terminal connected to a second node N2. The first terminal of the first transistor T1 may be directly connected to a power line PL that transmits the first power voltage ELVDD.

The second transistor T2 may transmit the data signal DS to a third node N3 in response to the write gate signal GW. The second transistor T2 may include a gate that receives the write gate signal GW, a first terminal that receives the data signal DS, and a second terminal connected to the third node N3.

The first capacitor C1 may be connected between the first node N1 and the third node N3. The first capacitor C1 may include a first terminal connected to the first node N1 and a second terminal connected to the third node N3.

The second capacitor C2 may be connected between the first node N1 and the power line PL. The second capacitor C2 may include a first terminal connected to the first node N1 and a second terminal that receives the first power voltage ELVDD.

The third transistor T3 may connect the first node N1 to the second node N2 in response to the compensation gate signal GC. The third transistor T3 may include a gate that receives the compensation gate signal GC, a first terminal connected to the first node N1, and a second terminal connected to the second node N2.

The fourth transistor T4 may include a gate, a first terminal connected to the second node N2, and a second terminal connected to the fourth node N4. An activation voltage level of a signal received by the gate of the fourth transistor T4 may be different from an activation voltage level of the write gate signal GW. A difference between the activation voltage level and a deactivation voltage level of the signal received by the gate of the fourth transistor T4 may be less than a difference between the activation voltage level and a deactivation voltage level of the write gate signal GW. In an embodiment, the activation voltage level of the signal received by the gate of the fourth transistor T4 may be higher than the activation voltage level of the write gate signal GW.

In an embodiment, the fourth transistor T4 may receive the emission signal EM. In this case, the fourth transistor T4 may connect the second node N2 to the fourth node N4 in response to the emission signal EM. Hereinafter, in an embodiment described with reference to FIGS. 2 to 8, the signal received by the gate of the fourth transistor T4 is the emission signal EM.

The fifth transistor T5 may transmit a ground voltage GND to the fourth node N4 in response to the bypass gate signal EB. The fifth transistor T5 may include a gate that receives the bypass gate signal EB, a first terminal that receives the ground voltage GND, and a second terminal connected to the fourth node N4.

A type of the first transistor T1 may be the same as a type of the fourth transistor T4. As used herein, the “type” of a transistor is whether the transistor is a p-type or an n-type. The fourth transistor T4 may be a p-type transistor when the first transistor T1 is a p-type transistor, and the fourth transistor T4 may be an n-type transistor when the first transistor T1 is an n-type transistor.

In an embodiment, as illustrated in FIG. 2, each of the first transistor T1, the second transistor T2, the third transistor T3, the fourth transistor T4, and the fifth transistor T5 may be a p-type transistor (e.g., a PMOS transistor). In another embodiment, at least one of the first transistor T1, the second transistor T2, the third transistor T3, the fourth transistor T4, and the fifth transistor T5 may be an n-type transistor (e.g., an NMOS transistor).

In an embodiment, as illustrated in FIG. 2, each of the first transistor T1, the second transistor T2, the third transistor T3, the fourth transistor T4, and the fifth transistor T5 may further include a fourth terminal (e.g., body, bulk or substrate) that receives the first power voltage ELVDD.

The light-emitting element OLED may include a first terminal (e.g., an anode) connected to the fourth node N4 and a second terminal (e.g., a cathode) that receives a second power voltage ELVSS. In an embodiment, the light-emitting element OLED may be one of an organic light-emitting diode, an inorganic light-emitting diode, a quantum dot light-emitting diode, and a micro light-emitting diode.

A frame period of the pixel PX may include an initialization period P1, a compensation period P2, a writing period P3, a bypass period P4, and an emission period P5. In the initialization period P1, the gate of the first transistor T1 may be initialized. In the compensation period P2, a threshold voltage of the first transistor T1 may be compensated. In the writing period P3, a data voltage Vdata may be written to the gate of the first transistor T1. In the bypass period P4, the first terminal of the light-emitting element OLED may be initialized. In the emission period P5, the light-emitting element OLED may emit light.

The emission signal EM may have an activation voltage level LVA1 or LVA2 in the initialization period P1, the bypass period P4, and the emission period P5, and may have a deactivation voltage level LVD in the compensation period P2 and the writing period P3.

The compensation gate signal GC may have an activation voltage level LVA in the initialization period P1 and the compensation period P2, and may have a deactivation voltage level LVD in the writing period P3, the bypass period P4, and the emission period P5.

The bypass gate signal EB may have an activation voltage level LVA in the initialization period P1, the compensation period P2, the writing period P3, and the bypass period P4, and may have a deactivation voltage level LVD in the emission period P5.

The write gate signal GW may have an activation voltage level LVA in the initialization period P1, compensation period P2, and writing period P3, and may have a deactivation voltage level LVD in the bypass period P4 and the emission period P5.

In the emission signal EM, the compensation gate signal GC, the bypass gate signal EB, and the write gate signal GW, the activation voltage level may be a logic low level, and the deactivation voltage level may be a logic high level. Accordingly, in the emission signal EM, the compensation gate signal GC, the bypass gate signal EB, and the write gate signal GW, the activation voltage level may be lower than the deactivation voltage level.

The activation voltage level LVA of the compensation gate signal GC, the activation voltage level LVA of the bypass gate signal EB, and the activation voltage level LVA of the write gate signal GW may be equal to each other. The deactivation voltage level LVD of the compensation gate signal GC, the deactivation voltage level LVD of the bypass gate signal EB, and the deactivation voltage level LVD of the write gate signal GW may be equal to each other.

The activation voltage level LVA1 or LVA2 of the emission signal EM may be different from the activation voltage level LVA of the compensation gate signal GC, the activation voltage level LVA of the bypass gate signal EB, and the activation voltage level LVA of the write gate signal GW. A difference between the activation voltage level LVA1 or LVA2 and the deactivation voltage level LVD of the emission signal EM may be less than a difference between the activation voltage level LVA and the deactivation voltage level LVD of the compensation gate signal GC, a difference between the activation voltage level LVA and the deactivation voltage level LVD of the bypass gate signal EB, and a difference between the activation voltage level LVA and the deactivation voltage level LVD of the write gate signal GW.

In an embodiment, the activation voltage level LVA1 or LVA2 of the emission signal EM may be higher than the activation voltage level LVA of the compensation gate signal GC, the activation voltage level LVA of the bypass gate signal EB, and the activation voltage level LVA of the write gate signal GW. For example, the activation voltage level LVA of the compensation gate signal GC, the activation voltage level LVA of the bypass gate signal EB, and the activation voltage level LVA of the write gate signal GW may be about −4.7 V. The activation voltage level LVA1 or LVA2 of the emission signal EM may be higher than −4.7 V.

The deactivation voltage level LVD of the emission signal EM may be equal to the deactivation voltage level LVD of the compensation gate signal GC, the deactivation voltage level LVD of the bypass gate signal EB, and the deactivation voltage level LVD of the write gate signal GW.

The first activation voltage level LVA1 of the emission signal EM in the initialization period P1 may be different from the second activation voltage level LVA2 of the emission signal EM in the bypass period P4 and the emission period P5. A difference between the first activation voltage level LVA1 and the deactivation voltage level LVD of the emission signal EM in the initialization period P1 may be greater than a difference between the second activation voltage level LVA2 and the deactivation voltage level LVD of the emission signal EM in the bypass period P4 and the emission period P5.

In an embodiment, the first activation voltage level LVA1 of the emission signal EM in the initialization period P1 may be lower than the second activation voltage level LVA2 of the emission signal EM in the bypass period P4 and the emission period P5. For example, the first activation voltage level LVA1 of the emission signal EM in the initialization period P1 may be about 0.5 V, and the second activation voltage level LVA2 of the emission signal EM in the bypass period P4 and the emission period P5 may be about 1.5 V to about 1.6 V.

The data signal DS may have a reference voltage Vref in the initialization period P1, the compensation period P2, the bypass period P4, and the emission period P5, and may have the data voltage Vdata in the writing period P3.

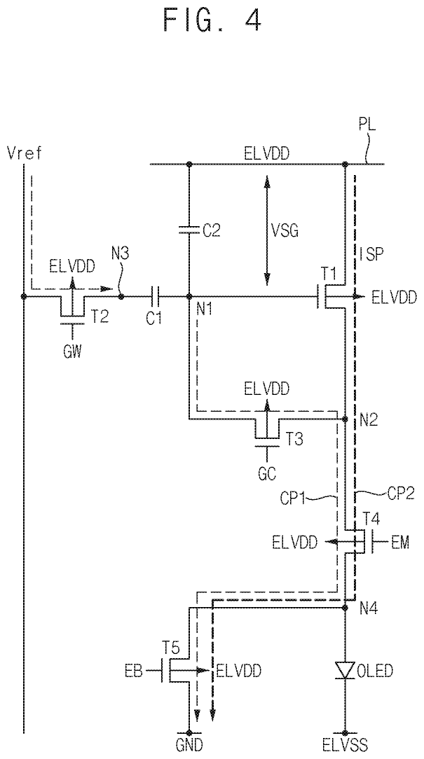

FIG. 4 is a diagram for describing the initialization period P1 of FIG. 3.

Referring to FIGS. 3 and 4, in the initialization period P1, the reference voltage Vref may be applied to the third node N3 through the second transistor T2 turned on in response to the activation voltage level LVA of the write gate signal GW. In an initialization period P1, a first current path CP1 may be formed from the first node N1 to a line that transmits the ground voltage GND through the third transistor T3 turned on in response to the activation voltage level LVA of the compensation gate signal GC, the fourth transistor T4 turned on in response to the first activation voltage level LVA1 of the emission signal EM, and the fifth transistor T5 turned on in response to the activation voltage level LVA of the bypass gate signal EB, and a voltage level of the first node N1 may decrease. However, since the first activation voltage level LVA1 of the emission signal EM is relatively high (since the first activation voltage level LVA1 of the emission signal EM is higher than the activation voltage level LVA of the write gate signal GW, the activation voltage level LVA of the compensation gate signal GC, and the activation voltage level LVA of the bypass gate signal EB), a current flowing through the turned-on fourth transistor T4 may be relatively small, and the current flowing through the first current path CP1 may be relatively small. Accordingly, in the initialization period P1, the voltage level of the first node N1 may be higher than the voltage level of the ground voltage GND.

In the initialization period P1, as the voltage level of the first node N1 decreases, a voltage difference VSG between the first terminal and the gate of the first transistor T1 may become greater than the threshold voltage of the first transistor T1, and the first transistor T1 may be turned on. Accordingly, in the initialization period P1, a second current path CP2 may be formed from the power line PL to the line that transmits the ground voltage GND through the turned-on first transistor T1, the fourth transistor T4 turned on in response to the first activation voltage level LVA1 of the emission signal EM, and the fifth transistor T5 turned on in response to the activation voltage level LVA of the bypass gate signal EB, and a short-circuit path current ISP may flow through the second current path CP2. However, since the voltage difference VSG between the first terminal and the gate of the first transistor T1 is relatively small (since the voltage level of the first node N1 is higher than the voltage level of the ground voltage GND), the current flowing through the turned-on first transistor T1 may be relatively small, and the short-circuit path current ISP flowing through the second current path CP2 may be relatively small.

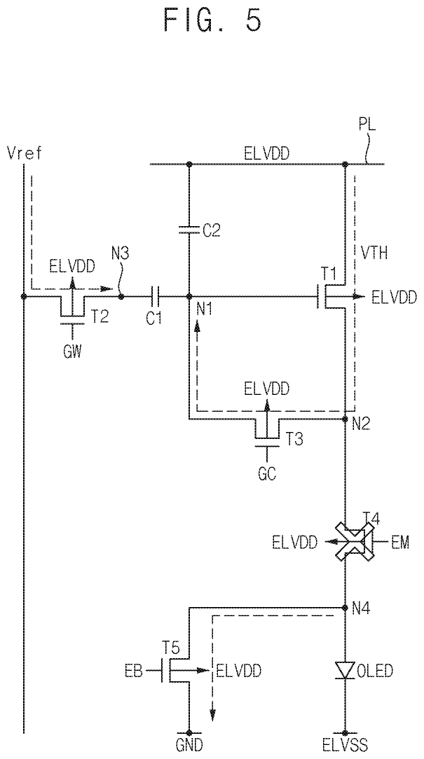

FIG. 5 is a diagram for describing the compensation period P2 of FIG. 3.

Referring to FIGS. 3 and 5, in the compensation period P2, the reference voltage Vref may be applied to the third node N3 through the second transistor T2 turned on in response to the activation voltage level LVA of the write gate signal GW. In the compensation period P2, a current path may be formed from the power line PL to the first node N1 through the turned-on first transistor T1 and the third transistor T3 turned on in response to the activation voltage level LVA of the compensation gate signal GC, and the voltage level of the first node N1 may increase until the first transistor T1 is turned off (until the voltage difference VSG between the first terminal and the gate of the first transistor T1 becomes equal to the threshold voltage VTH of the first transistor T1). Accordingly, in the compensation period P2, the voltage of the first node N1 may be equal to a value ELVDD-VTH obtained by subtracting the threshold voltage VTH of the first transistor T1 from the first power voltage ELVDD. In the compensation period P2, the ground voltage GND may be applied to the fourth node N4 through the fifth transistor T5 turned on in response to the activation voltage level LVA of the bypass gate signal EB. The threshold voltage VTH of the first transistor T1 may be compensated for by a diode connection scheme in the compensation period P2.

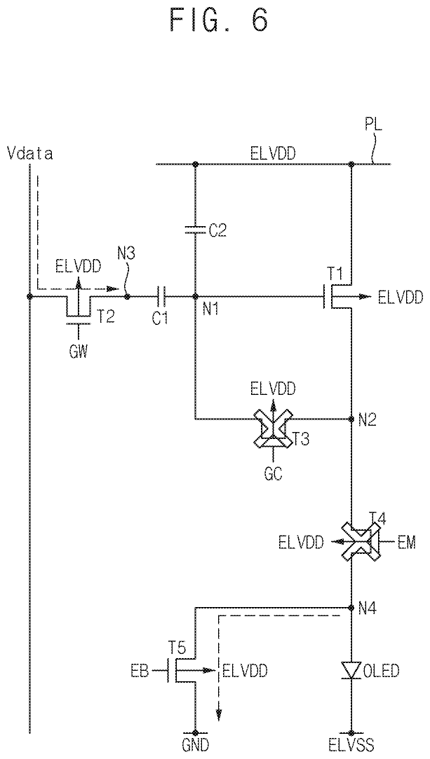

FIG. 6 is a diagram for describing the writing period P3 of FIG. 3.

Referring to FIGS. 3 and 6, in the writing period P3, the data voltage Vdata may be applied to the third node N3 through the second transistor T2 turned on in response to the activation voltage level LVA of the write gate signal GW, and accordingly, a voltage of the third node N3 may change from the reference voltage Vref to the data voltage Vdata. In the writing period P3, due to a coupling effect of the first capacitor C1, the voltage VN1 of the first node N1 may be calculated by mathematical formula 1.

$$V N 1 = ELVDD - V TH + \frac{C 1}{C 1 + C 2} \times ( V data - V ref ) \qquad [ Mathematical Formula 1 ]$$

A voltage of the gate of the first transistor T1 may be equal to the voltage VN1 of the first node N1 calculated by mathematical formula 1, and accordingly, the first transistor T1 may be turned on in the writing period P3. In the writing period P3, the ground voltage GND may be applied to the fourth node N4 through the fifth transistor T5 turned on in response to the activation voltage level LVA of the bypass gate signal EB.

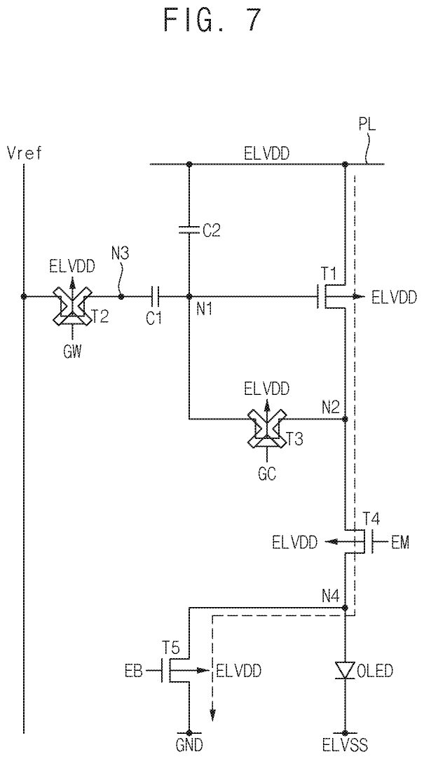

FIG. 7 is a diagram for describing the bypass period P4 of FIG. 3.

Referring to FIGS. 3 and 7, in the bypass period P4, a current path may be formed from the power line PL to the line that transmits the ground voltage GND through the turned-on first transistor T1, the fourth transistor T4 turned on in response to the second activation voltage level LVA2 of the emission signal EM, and the fifth transistor T5 turned on in response to the activation voltage level LVA of the bypass gate signal EB, and a current may flow through the current path. Since the second activation voltage level LVA2 of the emission signal EM in the bypass period P4 is higher than the first activation voltage level LVA1 of the emission signal EM in the initialization period P1, the current flowing through the current path in the bypass period P4 may be less than the short-circuit path current ISP flowing through the second current path CP2 in the initialization period P1. In the bypass period P4, charges stored in the fourth node N4 by a parasitic capacitance of the light-emitting element OLED may be discharged to the line that transmits the ground voltage GND, and accordingly, black expression capability of the light-emitting element OLED may be improved.

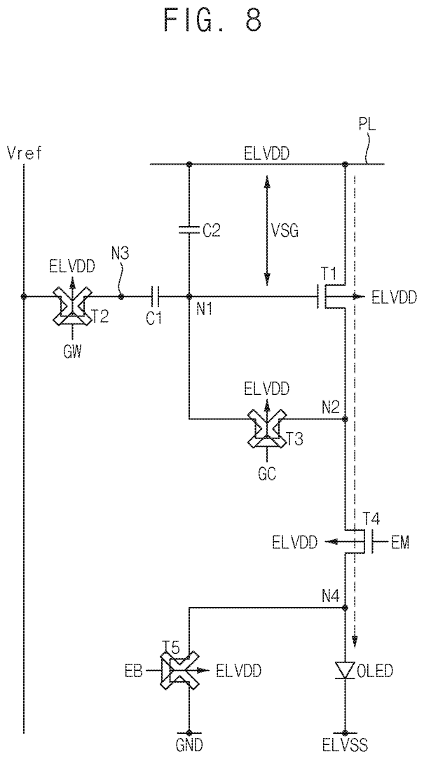

FIG. 8 is a diagram for describing the emission period P5 of FIG. 3.

Referring to FIGS. 3 and 8, in the emission period P5, a current path may be formed from the power line PL to a line that transmits the second power voltage ELVSS through the turned-on first transistor T1, the fourth transistor T4 turned on in response to the second activation voltage level LVA2 of the emission signal EM, and the light-emitting element OLED, and a driving current may flow through the current path. Since the second activation voltage level LVA2 of the emission signal EM in the emission period P5 is higher than the first activation voltage level LVA1 of the emission signal EM in the initialization period P1, the driving current flowing through the current path in the emission period P5 may be less than the short-circuit path current ISP flowing through the second current path CP2 in the initialization period P1. In the emission period P5, the light-emitting element OLED may emit light with a luminance corresponding to the driving current. In the emission period P5, the driving current IOLED may be calculated by mathematical formula 2.

$$\begin{matrix}IOLED = K \times {( ELVDD - V N 1 - V TH )}^{2} \\ = K \times {( \frac{C 1}{C 1 + C 2} )}^{2} {( V data - V ref )}^{2}\end{matrix} \qquad [ Mathematical Formula 2 ]$$

In mathematical formula 2, K is a proportional constant. According to mathematical formula 2, the driving current IOLED may be determined by the data voltage Vdata regardless of the threshold voltage VTH of the first transistor T1, and in the emission period P5, the light-emitting element OLED may emit light with a luminance corresponding to the data voltage Vdata.

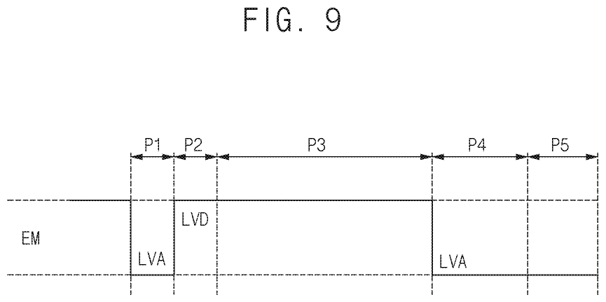

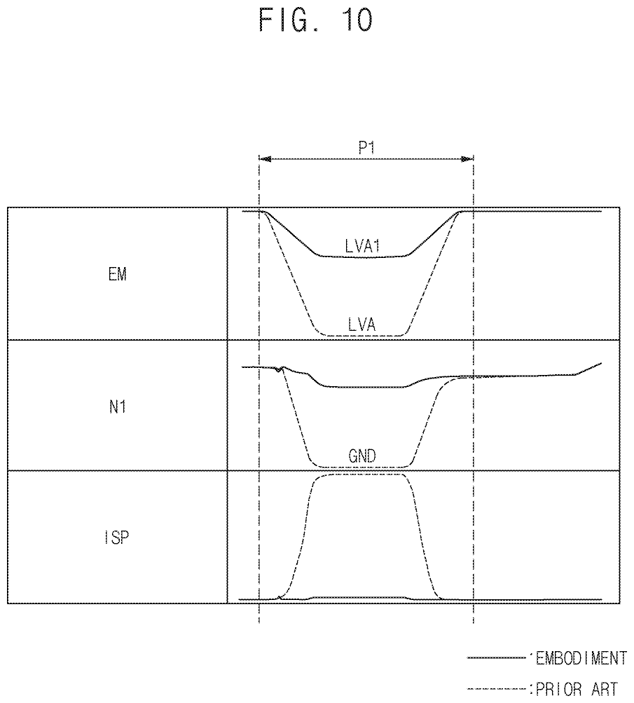

FIG. 9 is a timing diagram illustrating an emission signal EM according to the prior art. FIG. 10 is a timing diagram illustrating the emission signal EM, the voltage of the first node N1, and the short-circuit path current ISP in the initialization period P1.

Referring to FIGS. 3, 4, 9, and 10, in the prior art, the activation voltage level LVA of the emission signal EM may be equal to the activation voltage level LVA of the compensation gate signal GC, the activation voltage level LVA of the bypass gate signal EB, and the activation voltage level LVA of the write gate signal GW. In the initialization period P1 of the prior art, the first current path CP1 may be formed from the first node N1 to the line that transmits the ground voltage GND through the third transistor T3 turned on in response to the activation voltage level LVA of the compensation gate signal GC, the fourth transistor T4 turned on in response to the activation voltage level LVA of the emission signal EM, and the fifth transistor T5 turned on in response to the activation voltage level LVA of the bypass gate signal EB, and the voltage level of the first node N1 may decrease. In the prior art, since the activation voltage level LVA of the emission signal EM is relatively low (since the activation voltage level LVA of the emission signal EM is equal to the activation voltage level LVA of the write gate signal GW, the activation voltage level LVA of the compensation gate signal GC, and the activation voltage level LVA of the bypass gate signal EB), a current flowing through the turned-on fourth transistor T4 may be relatively large, and a current flowing through the first current path CP1 may be relatively large. Accordingly, in the initialization period P1 of the prior art, the voltage level of the first node N1 may be equal to the voltage level of the ground voltage GND.

In the initialization period P1 of the prior art, as the voltage level of the first node N1 becomes equal to the voltage level of the ground voltage GND, the voltage difference VSG between the first terminal and the gate of the first transistor T1 may become greater than the threshold voltage of the first transistor T1, and the first transistor T1 may be turned on. Accordingly, in the initialization period P1 of the prior art, the second current path CP2 may be formed from the power line PL to the line that transmits the ground voltage GND through the turned-on first transistor T1, the fourth transistor T4 turned on in response to the activation voltage level LVA of the emission signal EM, and the fifth transistor T5 turned on in response to the activation voltage level LVA of the bypass gate signal EB, and a short-circuit path current ISP may flow through the second current path CP2. In the prior art, since the voltage difference VSG between the first terminal and the gate of the first transistor T1 is relatively large (since the voltage level of the first node N1 is equal to the voltage level of the ground voltage GND), a current flowing through the turned-on first transistor T1 may be relatively large, and the short-circuit path current ISP flowing through the second current path CP2 may be relatively large. When the short-circuit path current ISP is large, a ripple may occur in the first power voltage ELVDD. When the ripple occurs in the first power voltage ELVDD in the compensation period P2, a relatively long time may be required to recover the first power voltage ELVDD, so that a time length of the compensation period P2 may increase, which may be detrimental to high-speed driving of the display device. Further, when the short-circuit path current ISP is large, a voltage of the fourth node N4 may increase, so that the black expression capability of the light-emitting element OLED may decrease, and a contrast of the display device may deteriorate.

In the embodiments of the present disclosure, since the activation voltage level LVA1 or LVA2 of the emission signal EM is higher than the activation voltage level LVA of the compensation gate signal GC, the activation voltage level LVA of the bypass gate signal EB, and the activation voltage level LVA of the write gate signal GW, in the initialization period P1, the voltage level of the first node N1 may be higher than the voltage level of the ground voltage GND. Accordingly, since the short-circuit path current ISP is relatively small, which may be advantageous for the high-speed driving of the display device 100, and the contrast of the display device 100 may be improved.

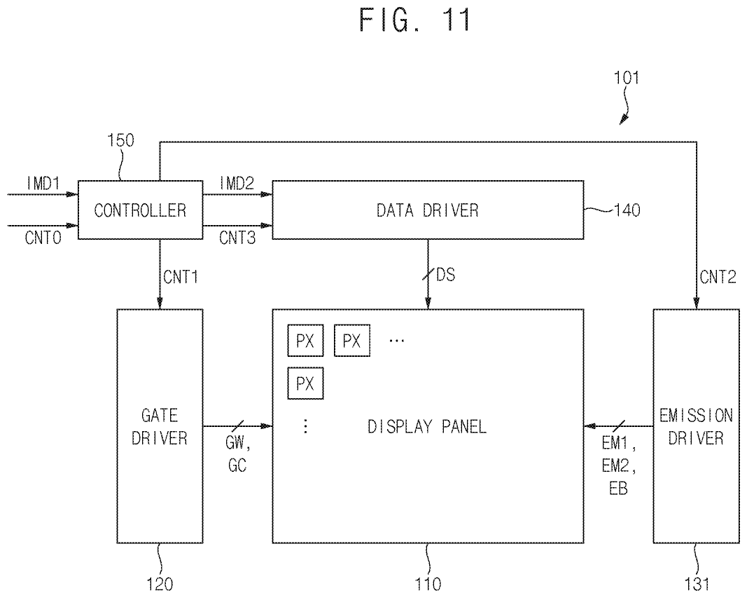

FIG. 11 is a block diagram illustrating a display device 101 according to an embodiment.

Referring to FIG. 11, the display device 101 may include a display panel 110, a gate driver 120, an emission driver 131, a data driver 140, and a controller 150. Descriptions of components of the display device 101 described with reference to FIG. 11, which are substantially the same as or similar to those of the display device 100 described with reference to FIG. 1, will be omitted.

The display panel 110 may include pixels PX. Each of the pixels PX may emit light based on a write gate signal GW, a compensation gate signal GC, a first emission signal EM1, a second emission signal EM2, a bypass gate signal EB, and a data signal DS. The first emission signal EM1 described with reference to FIGS. 11 to 13 may be the same as the emission signal EM described with reference to FIGS. 1 to 3.

The emission driver 131 may provide the first emission signal EM1, the second emission signal EM2, and the bypass gate signal EB to each of the pixels PX. The emission driver 131 may generate the first emission signal EM1, the second emission signal EM2, and the bypass gate signal EB on a pixel row basis. The emission driver 131 may generate the first emission signal EM1, the second emission signal EM2, and the bypass gate signal EB based on a second control signal CNT2. The second control signal CNT2 may include a first emission start signal, a second emission start signal, a bypass gate start signal, emission clock signals, etc.

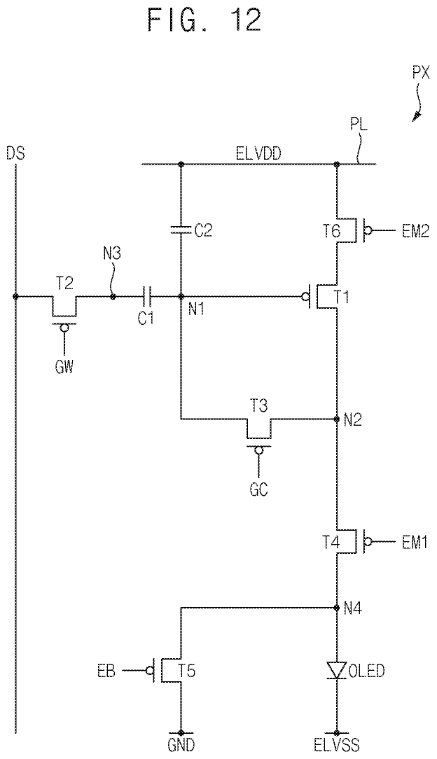

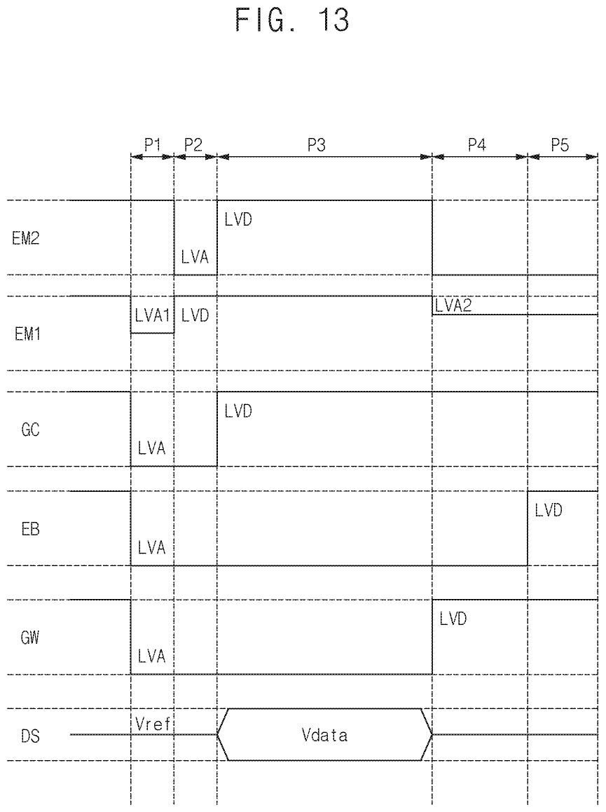

FIG. 12 is a circuit diagram illustrating an example of the pixel PX of FIG. 11. FIG. 13 is a timing diagram illustrating the signals EM2, EM1, GC, EB, GW, and DS of FIG. 12.

Referring to FIGS. 12 and 13, the pixel PX may include a first transistor T1, a second transistor T2, a first capacitor C1, a second capacitor C2, a third transistor T3, a fourth transistor T4, a fifth transistor T5, a sixth transistor T6, and a light-emitting element OLED. Descriptions of components of the pixel PX described with reference to FIGS. 12 and 13, which are substantially the same as or similar to those of the pixel PX described with reference to FIGS. 2 and 3, will be omitted.

The first transistor T1 may include a gate connected to a first node N1, a first terminal that receives a first power voltage ELVDD, and a second terminal connected to a second node N2. The first terminal of the first transistor T1 may be connected to a power line PL through the sixth transistor T6.

The fourth transistor T4 may connect the second node N2 to a fourth node N4 in response to the first emission signal EM1. The fourth transistor T4 may include a gate that receives the first emission signal EM1, a first terminal connected to the second node N2, and a second terminal connected to the fourth node N4.

The sixth transistor T6 may transmit the first power voltage ELVDD to the first terminal of the first transistor T1 in response to the second emission signal EM2. The sixth transistor T6 may include a gate that receives the second emission signal EM2, a first terminal that receives the first power voltage ELVDD, and a second terminal connected to the first terminal of the first transistor T1.

In an embodiment, as illustrated in FIG. 12, each of the first transistor T1, the second transistor T2, the third transistor T3, the fourth transistor T4, the fifth transistor T5, and the sixth transistor T6 may be a p-type transistor (e.g., a PMOS transistor). In an embodiment, at least one of the first transistor T1, the second transistor T2, the third transistor T3, the fourth transistor T4, the fifth transistor T5, and the sixth transistor T6 may be an n-type transistor (e.g., an NMOS transistor).

The second emission signal EM2 may have an activation voltage level LVA in the compensation period P2, the bypass period P4, and the emission period P5, and may have a deactivation voltage level LVD in the initialization period P1 and the writing period P3. The activation voltage level LVA of the second emission signal EM2 may be a logic low level, and the deactivation voltage level LVD of the second emission signal EM2 may be a logic high level. Accordingly, the activation voltage level LVA of the second emission signal EM2 may be lower than the deactivation voltage level LVD of the second emission signal EM2. The activation voltage level LVA of the second emission signal EM2 may be equal to the activation voltage level LVA of the compensation gate signal GC, the activation voltage level LVA of the bypass gate signal EB, and the activation voltage level LVA of the write gate signal GW. The deactivation voltage level LVD of the second emission signal EM2 may be equal to the deactivation voltage level LVD of the first emission signal EM1, the deactivation voltage level LVD of the compensation gate signal GC, the deactivation voltage level LVD of the bypass gate signal EB, and the deactivation voltage level LVD of the write gate signal GW.

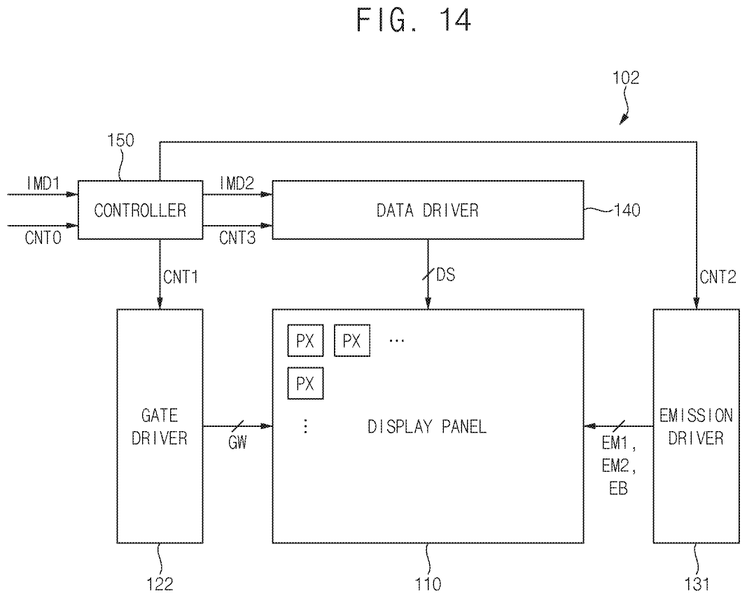

FIG. 14 is a block diagram illustrating a display device 102 according to an embodiment.

Referring to FIG. 14, the display device 102 may include a display panel 110, a gate driver 122, an emission driver 131, a data driver 140, and a controller 150. Descriptions of components of the display device 102 described with reference to FIG. 14, which are substantially the same as or similar to those of the display device 100 described with reference to FIG. 1 and/or the display device 101 described with reference to FIG. 11, will be omitted.

The display panel 110 may include pixels PX. Each of the pixels PX may emit light based on a write gate signal GW, a first emission signal EM1, a second emission signal EM2, a bypass gate signal EB, and a data signal DS.

The gate driver 122 may provide the write gate signal GW to each of the pixels PX. The gate driver 122 may generate the write gate signal GW on a pixel row basis. The gate driver 122 may generate the write gate signal GW based on a first control signal CNT1. The first control signal CNT1 may include a write gate start signal, gate clock signals, etc.

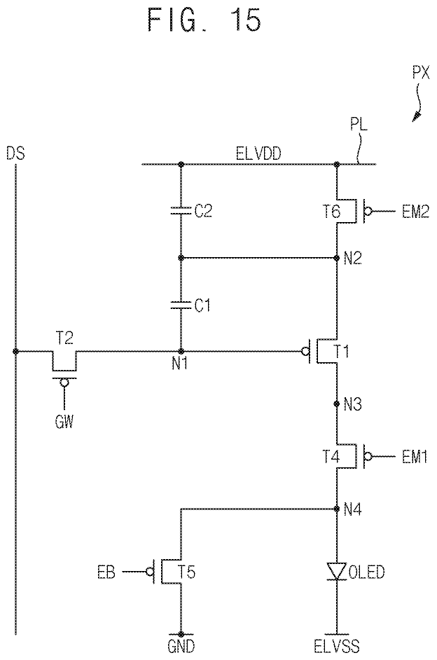

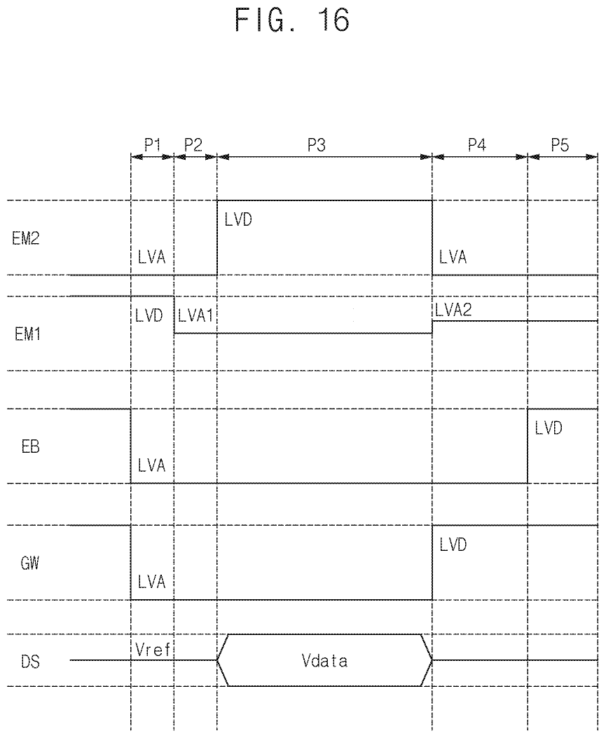

FIG. 15 is a circuit diagram illustrating an example of the pixel PX of FIG. 14. FIG. 16 is a timing diagram illustrating signals EM2, EM1, EB, GW, and DS of FIG. 15.

Referring to FIGS. 15 and 16, the pixel PX may include a first transistor T1, a second transistor T2, a first capacitor C1, a second capacitor C2, a fourth transistor T4, a fifth transistor T5, a sixth transistor T6, and a light-emitting element OLED. Descriptions of components of the pixel PX described with reference to FIGS. 15 and 16, which are substantially the same as or similar to those of the pixel PX described with reference to FIGS. 2 and 3 and/or the pixel PX described with reference to FIGS. 12 and 13, will be omitted.

The first transistor T1 may include a gate connected to a first node N1, a first terminal connected to a second node N2, and a second terminal connected to a third node N3.

The second transistor T2 may transmit the data signal DS to the first node N1 in response to the write gate signal GW. The second transistor T2 may include a gate that receives the write gate signal GW, a first terminal that receives the data signal DS, and a second terminal connected to the first node N1.

The first capacitor C1 may be connected between the first node N1 and the second node N2. The first capacitor C1 may include a first terminal connected to the first node N1 and a second terminal connected to the second node N2.

The second capacitor C2 may be connected between the second node N2 and the power line PL. The second capacitor C2 may include a first terminal connected to the second node N2 and a second terminal that receives the first power voltage ELVDD.

The fourth transistor T4 may connect the third node N3 to the fourth node N4 in response to the first emission signal EM1. The fourth transistor T4 may include a gate that receives the first emission signal EM1, a first terminal connected to the third node N3, and a second terminal connected to the fourth node N4.

The sixth transistor T6 may transmit the first power voltage ELVDD to the second node N2 in response to the second emission signal EM2. The sixth transistor T6 may include a gate that receives the second emission signal EM2, a first terminal that receives the first power voltage ELVDD, and a second terminal connected to the second node N2.

In an embodiment, as illustrated in FIG. 15, each of the first transistor T1, the second transistor T2, the fourth transistor T4, the fifth transistor T5, and the sixth transistor T6 may be a p-type transistor (e.g., a PMOS transistor). In an embodiment, at least one of the first transistor T1, the second transistor T2, the fourth transistor T4, the fifth transistor T5, and the sixth transistor T6 may be an n-type transistor (e.g., an NMOS transistor).

The second emission signal EM2 may have an activation voltage level LVA in the initialization period P1, the compensation period P2, the bypass period P4, and the emission period P5, and may have a deactivation voltage level LVD in the writing period P3.

The first emission signal EM1 may have a deactivation voltage level LVD in the initialization period P1, and may have an activation voltage level LVA1 or LVA2 in the compensation period P2, the writing period P3, the bypass period P4, and the emission period P5.

The first activation voltage level LVA1 of the first emission signal EM1 in the compensation period P2 and the writing period P3 may be different from the second activation voltage level LVA2 of the first emission signal EM1 in the bypass period P4 and the emission period P5. A difference between the first activation voltage level LVA1 and the deactivation voltage level LVD of the first emission signal EM1 in the compensation period P2 and the writing period P3 may be greater than a difference between the second activation voltage level LVA2 and the deactivation voltage level LVD of the first emission signal EM1 in the bypass period P4 and the emission period P5.

In an embodiment, the first activation voltage level LVA1 of the first emission signal EM1 in the compensation period P2 and the writing period P3 may be lower than the second activation voltage level LVA2 of the first emission signal EM1 in the bypass period P4 and the emission period P5.

In the initialization period P1, the reference voltage Vref may be applied to the first node N1 through the second transistor T2 turned on in response to the activation voltage level LVA of the write gate signal GW.

In the compensation period P2, the reference voltage Vref may be applied to the first node N1 through the second transistor T2 turned on in response to the activation voltage level LVA of the write gate signal GW. In the compensation period P2, a current path may be formed from the power line PL to a line that transmits the ground voltage GND through the sixth transistor T6 turned on in response to the activation voltage level LVA of the second emission signal EM2, the turned-on first transistor T1, the fourth transistor T4 turned on in response to the first activation voltage level LVA1 of the first emission signal EM1, and the fifth transistor T5 turned on in response to the activation voltage level LVA of the bypass gate signal EB, and the voltage level of the second node N2 may increase until the first transistor T1 is turned off (until the voltage difference VSG between the first terminal and the gate of the first transistor T1 becomes equal to the threshold voltage of the first transistor T1). Accordingly, in the compensation period P2, the threshold voltage of the first transistor T1 may be stored in the first capacitor C1. The threshold voltage of the first transistor T1 may be compensated for by a source follower scheme in the compensation period P2.

In the writing period P3, the data voltage Vdata may be applied to the first node N1 through the second transistor T2 turned on in response to the activation voltage level LVA of the write gate signal GW.

In the bypass period P4, a current path may be formed from the power line PL to the line that transmits the ground voltage GND through the sixth transistor T6 turned on in response to the activation voltage level LVA of the second emission signal EM2, the turned-on first transistor T1, the fourth transistor T4 turned on in response to the second activation voltage level LVA2 of the first emission signal EM1, and the fifth transistor T5 turned on in response to the activation voltage level LVA of the bypass gate signal EB, and a current may flow through the current path.

In the emission period P5, a current path may be formed from the power line PL to a line that transmits the second power voltage ELVSS through the sixth transistor T6 turned on in response to the activation voltage level LVA of the second emission signal EM2, the turned-on first transistor T1, the fourth transistor T4 turned on in response to the second activation voltage level LVA2 of the first emission signal EM1, and the light-emitting element OLED, and a driving current may flow through the current path. In the emission period P5, the light-emitting element OLED may emit light with a luminance corresponding to the driving current. The driving current may be determined by the data voltage Vdata regardless of the threshold voltage of the first transistor T1, and in the emission period P5, the light-emitting element OLED may emit light with a luminance corresponding to the data voltage Vdata.

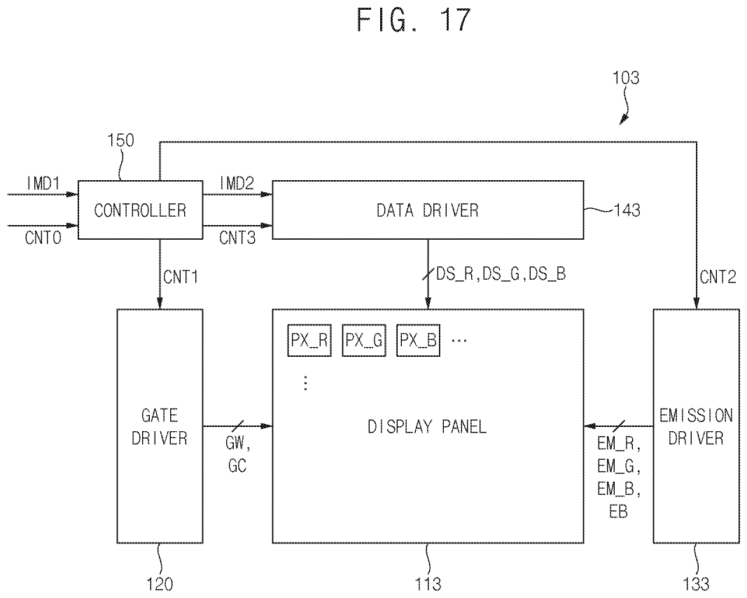

FIG. 17 is a block diagram illustrating a display device 103 according to an embodiment.

Referring to FIG. 17, the display device 103 may include a display panel 113, a gate driver 120, an emission driver 133, a data driver 143, and a controller 150. Descriptions of components of the display device 103 described with reference to FIG. 17, which are substantially the same as or similar to those of the display device 100 described with reference to FIG. 1, will be omitted.

The display panel 113 may include red pixels PX_R, green pixels PX_G, and blue pixels PX_B. Each of the red pixels PX_R may emit light based on a write gate signal GW, a compensation gate signal GC, a red emission signal EM_R, a bypass gate signal EB, and a red data signal DS_R. Each of the green pixels PX_G may emit light based on the write gate signal GW, the compensation gate signal GC, a green emission signal EM_G, the bypass gate signal EB, and a green data signal DS_G. Each of the blue pixels PX_B may emit light based on the write gate signal GW, the compensation gate signal GC, a blue emission signal EM_B, the bypass gate signal EB, and a blue data signal DS_B.

The emission driver 133 may provide the red emission signal EM_R and the bypass gate signal EB to each of the red pixels PX_R, may provide the green emission signal EM_R and the bypass gate signal EB to each of the green pixels PX_G, and may provide the blue emission signal EM_B and the bypass gate signal EB to each of the blue pixels PX_B. The emission driver 133 may generate the red emission signal EM_R, the green emission signal EM_G, the blue emission signal EM_B, and the bypass gate signal EB based on a second control signal CNT2. The second control signal CNT2 may include a red emission start signal, a green emission start signal, a blue emission start signal, a bypass gate start signal, emission clock signals, etc.

The data driver 143 may provide the red data signal DS_R to each of the red pixels PX_R, may provide the green data signal DS_G to each of the green pixels PX_G, and may provide the blue data signal DS_B to each of the blue pixels PX_B. The data driver 143 may generate the red data signal DS_R, the green data signal DS_G, and the blue data signal DS_B based on output image data IMD2 and a third control signal CNT3.

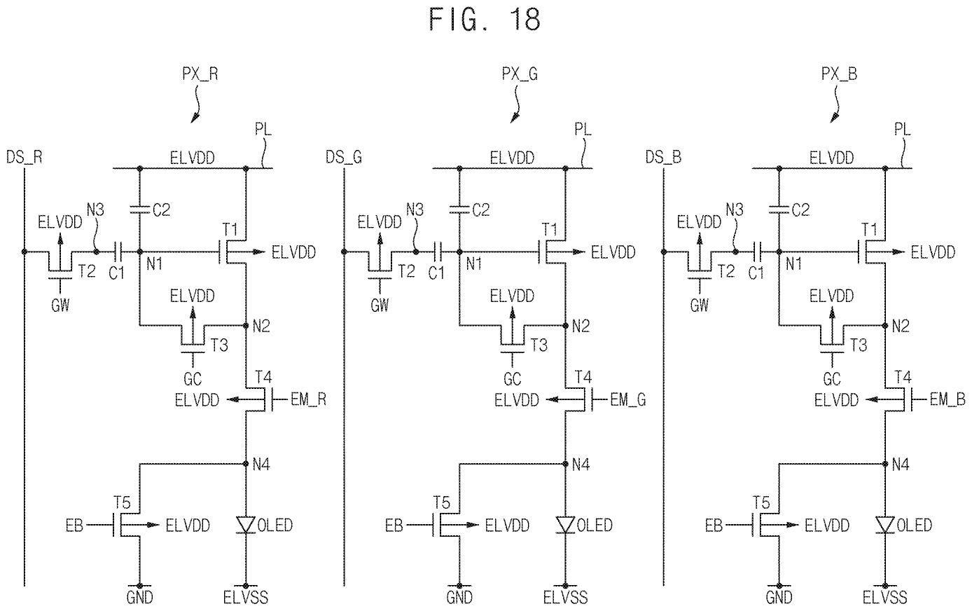

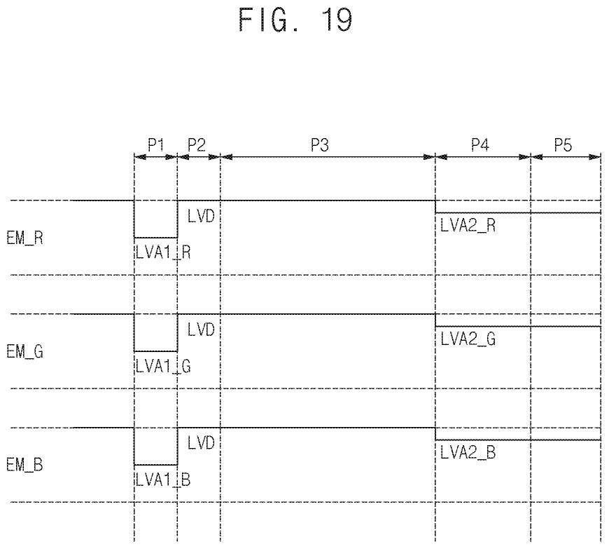

FIG. 18 is a circuit diagram illustrating an example of the pixels PX_R, PX_G, and PX_B of FIG. 17. FIG. 19 is a timing diagram illustrating signals EM_R, EM_G, and EM_B of FIG. 18.

Referring to FIGS. 18 and 19, each of the red pixel PX_R, the green pixel PX_G, and the blue pixel PX_B may include a first transistor T1, a second transistor T2, a first capacitor C1, a second capacitor C2, a third transistor T3, a fourth transistor T4, a fifth transistor T5, and a light-emitting element OLED. Descriptions of components of each of the red pixel PX_R, the green pixel PX_G, and the blue pixel PX_B described with reference to FIGS. 18 and 19, which are substantially the same as or similar to those of the pixel PX described with reference to FIGS. 2 and 3, will be omitted.

The second transistor T2 of the red pixel PX_R may transmit the red data signal DS_R to the third node N3 in response to the write gate signal GW. The second transistor T2 of the red pixel PX_R may include a gate that receives the write gate signal GW, a first terminal that receives the red data signal DS_R, and a second terminal connected to the third node N3.

The second transistor T2 of the green pixel PX_G may transmit the green data signal DS_G to the third node N3 in response to the write gate signal GW. The second transistor T2 of the green pixel PX_G may include a gate that receives the write gate signal GW, a first terminal that receives the green data signal DS_G, and a second terminal connected to the third node N3.

The second transistor T2 of the blue pixel PX_B may transmit the blue data signal DS_B to the third node N3 in response to the write gate signal GW. The second transistor T2 of the blue pixel PX_B may include a gate that receives the write gate signal GW, a first terminal that receives the blue data signal DS_B, and a second terminal connected to the third node N3.

The fourth transistor T4 of the red pixel PX_R may connect the second node N2 to the fourth node N4 in response to the red emission signal EM_R. The fourth transistor T4 of the red pixel PX_R may include a gate that receives the red emission signal EM_R, a first terminal connected to the second node N2, and a second terminal connected to the fourth node N4.

The fourth transistor T4 of the green pixel PX_G may connect the second node N2 to the fourth node N4 in response to the green emission signal EM_G. The fourth transistor T4 of the green pixel PX_G may include a gate that receives the green emission signal EM_G, a first terminal connected to the second node N2, and a second terminal connected to the fourth node N4.

The fourth transistor T4 of the blue pixel PX_B may connect the second node N2 to the fourth node N4 in response to the blue emission signal EM_B. The fourth transistor T4 of the blue pixel PX_B may include a gate that receives the blue emission signal EM_B, a first terminal connected to the second node N2, and a second terminal connected to the fourth node N4.

The red emission signal EM_R may have an activation voltage level LVA1_R or LVA2_R in the initialization period P1, the bypass period P4, and the emission period P5, and may have a deactivation voltage level LVD in the compensation period P2 and the writing period P3. The green emission signal EM_G may have an activation voltage level LVA1_G or LVA2_G in the initialization period P1, the bypass period P4, and the emission period P5, and may have a deactivation voltage level LVD in the compensation period P2 and the writing period P3. The blue emission signal EM_B may have an activation voltage level LVA1_B or LVA2_B in the initialization period P1, the bypass period P4, and the emission period P5, and may have a deactivation voltage level LVD in the compensation period P2 and the writing period P3.

The activation voltage level LVA1_R or LVA2_R of the red emission signal EM_R, the activation voltage level LVA1_G or LVA2_G of the green emission signal EM_G, and the activation voltage level LVA1_B or LVA2_B of the blue emission signal EM_B may be different from each other. Since the efficiency and threshold voltage characteristics of the light-emitting element OLED are different in the red pixel PX_R, the green pixel PX_G, and the blue pixel PX_B, the red emission signal EM_R, the green emission signal EM_G, and the blue emission signal EM_B having different activation voltage levels may be provided to the red pixel PX_R, the green pixel PX_G, and the blue pixel PX_B, respectively. For example, in the emission period P5, the red emission signal EM_R, the green emission signal EM_G, and the blue emission signal EM_B having different second activation voltage levels LVA2_R, LVA2_G, and LVA2_B may be provided to the red pixel PX_R, the green pixel PX_G, and the blue pixel PX_B, respectively, so that the luminance uniformity and the lifespan balance may be optimized between the red pixel PX_R, the green pixel PX_G, and the blue pixel PX_B.

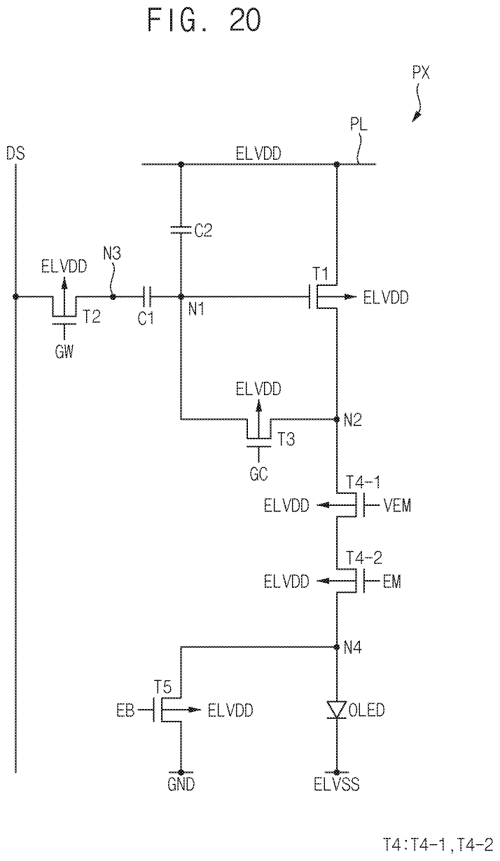

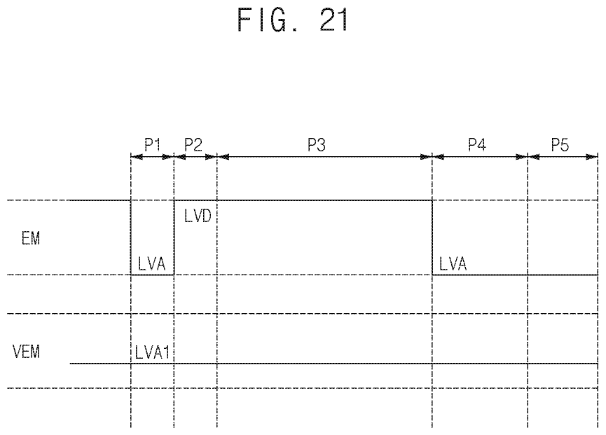

FIG. 20 is a circuit diagram illustrating an example of the pixel PX of FIG. 1. FIG. 21 is a timing diagram illustrating signals EM and VEM of FIG. 20.

Referring to FIGS. 20 and 21, the pixel PX may include a first transistor T1, a second transistor T2, a first capacitor C1, a second capacitor C2, a third transistor T3, a fourth transistor T4, a fifth transistor T5, and a light-emitting element OLED. Descriptions of components of the pixel PX described with reference to FIGS. 20 and 21, which are substantially the same as or similar to those of the pixel PX described with reference to FIGS. 2 and 3, will be omitted.

The fourth transistor T4 may include a fourth-first transistor T4-1 and a fourth-second transistor T4-2. The fourth-first transistor T4-1 may include a gate that receives a bias voltage VEM, a first terminal connected to the second node N2, and a second terminal. The fourth-second transistor T4-2 may include a gate that receives the emission signal EM, a first terminal connected to the second terminal of the fourth-first transistor T4-1, and a second terminal connected to the fourth node N4.

The emission signal EM may have an activation voltage level LVA in the initialization period P1, the bypass period P4, and the emission period P5, and may have a deactivation voltage level LVD in the compensation period P2 and the writing period P3. The activation voltage level LVA of the emission signal EM may be equal to the activation voltage level of the compensation gate signal GC, the activation voltage level of the bypass gate signal EB, and the activation voltage level of the write gate signal GW.

The bias voltage VEM may have a first activation voltage level LVA1 in the initialization period P1, the compensation period P2, the writing period P3, the bypass period P4, and the emission period P5. In an embodiment, the bias voltage level VEM may be a constant voltage.

The first activation voltage level LVA1 of the bias voltage VEM may be a logic low level. The first activation voltage level LVA1 of the bias voltage VEM may be different from the activation voltage level LVA of the emission signal EM. In an embodiment, the first activation voltage level LVA1 of the bias voltage VEM may be higher than the activation voltage level LVA of the emission signal EM.

In an embodiment described with reference to FIGS. 20 and 21, the fourth transistor T4 may be formed as a stacked cascode structure including the fourth-first transistor T4-1 and the fourth-second transistor T4-2. The bias voltage VEM, which is a constant voltage, may be applied to the gate of the fourth-first transistor T4-1, so that the fourth-first transistor T4-1 may perform a cascode function. The emission signal EM, which is a switching signal, may be applied to the gate of the fourth-second transistor T4-2, so that the fourth-second transistor T4-2 may control an emission time of the light-emitting element OLED.

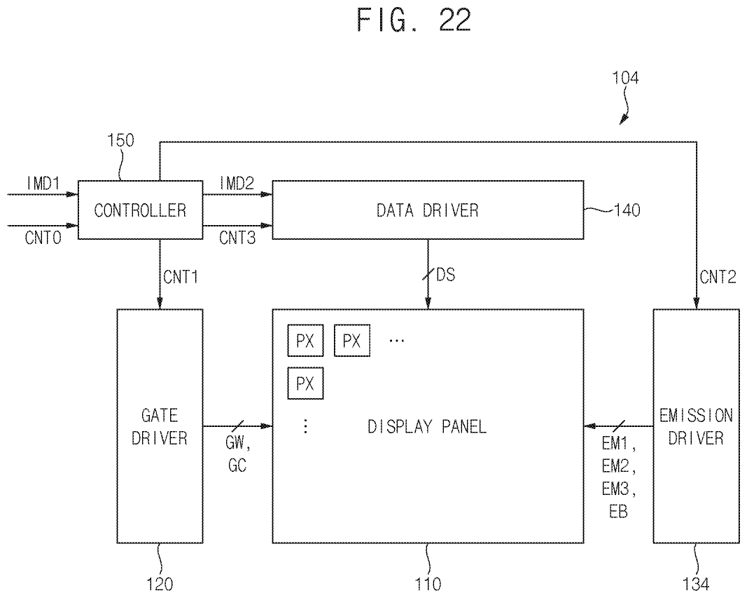

FIG. 22 is a block diagram illustrating a display device 104 according to an embodiment.

Referring to FIG. 22, the display device 104 may include a display panel 110, a gate driver 120, an emission driver 134, a data driver 140, and a controller 150. Descriptions of components of the display device 104 described with reference to FIG. 22, which are substantially the same as or similar to those of the display device 100 described with reference to FIG. 1, will be omitted.

The display panel 110 may include pixels PX. Each of the pixels PX may emit light based on a write gate signal GW, a compensation gate signal GC, a first emission signal EM1, a second emission signal EM2, a third emission signal EM3, a bypass gate signal EB, and a data signal DS.

The emission driver 134 may provide the first emission signal EM1, the second emission signal EM2, the third emission signal EM3, and the bypass gate signal EB to each of the pixels PX. The emission driver 134 may generate the first emission signal EM1, the second emission signal EM2, the third emission signal EM3, and the bypass gate signal EB on a pixel row basis. The emission driver 134 may generate the first emission signal EM1, the second emission signal EM2, the third emission signal EM3, and the bypass gate signal EB based on a second control signal CNT2. The second control signal CNT2 may include a first emission start signal, a second emission start signal, a third emission start signal, a bypass gate start signal, emission clock signals, etc.

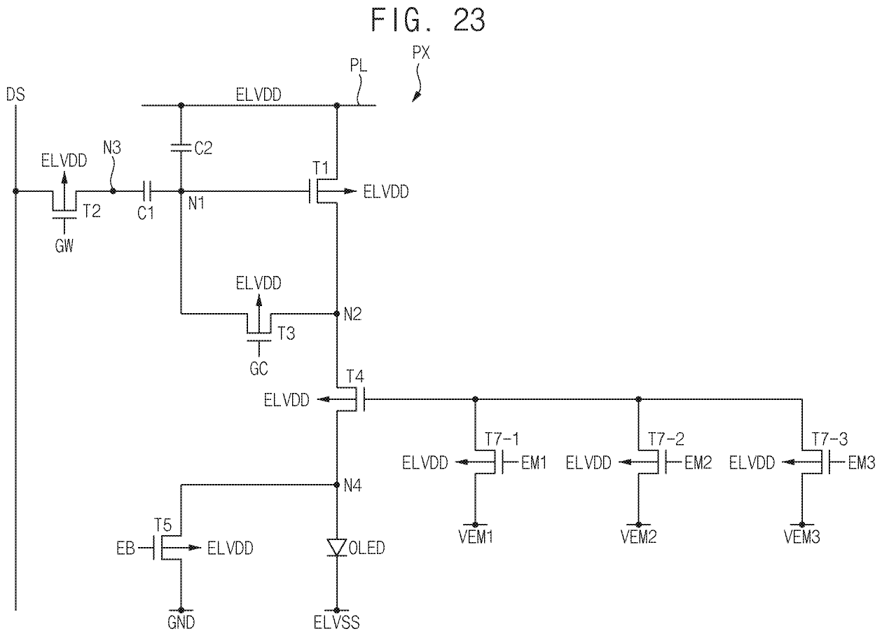

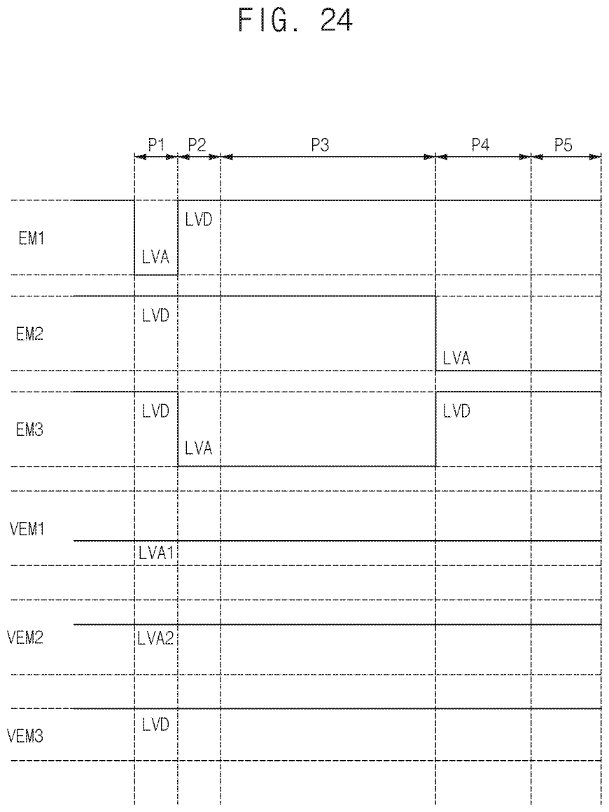

FIG. 23 is a circuit diagram illustrating an example of the pixel PX of FIG. 22. FIG. 24 is a timing diagram illustrating signals EM1, EM2, EM3, VEM1, VEM2, and VEM3 of FIG. 23.

Referring to FIGS. 23 and 24, the pixel PX may include a first transistor T1, a second transistor T2, a first capacitor C1, a second capacitor C2, a third transistor T3, a fourth transistor T4, a fifth transistor T5, a seventh-first transistor T7-1, a seventh-second transistor T7-2, a seventh-third transistor T7-3, and a light-emitting element OLED. Descriptions of components of the pixel PX described with reference to FIGS. 23 and 24, which are substantially the same as or similar to those of the pixel PX described with reference to FIGS. 2 and 3, will be omitted.

The fourth transistor T4 may include a gate, a first terminal connected to the second node N2, and a second terminal connected to the fourth node N4.

The seventh-first transistor T7-1 may transmit a first bias voltage VEM1 to the gate of the fourth transistor T4 in response to the first emission signal EM1. The seventh-first transistor T7-1 may include a gate that receives the first emission signal EM1, a first terminal that receives the first bias voltage VEM1, and a second terminal connected to the gate of the fourth transistor T4.

The seventh-second transistor T7-2 may transmit a second bias voltage VEM2 to the gate of the fourth transistor T4 in response to the second emission signal EM2. The seventh-second transistor T7-2 may include a gate that receives the second emission signal EM2, a first terminal that receives the second bias voltage VEM2, and a second terminal connected to the gate of the fourth transistor T4.

The seventh-third transistor T7-3 may transmit a third bias voltage VEM3 to the gate of the fourth transistor T4 in response to the third emission signal EM3. The seventh-third transistor T7-3 may include a gate that receives the third emission signal EM3, a first terminal that receives the third bias voltage VEM3, and a second terminal connected to the gate of the fourth transistor T4.

The first emission signal EM1 may have an activation voltage level LVA in the initialization period P1, and may have a deactivation voltage level LVD in the compensation period P2, the writing period P3, the bypass period P4, and the emission period P5. The second emission signal EM2 may have a deactivation voltage level LVD in the initialization period P1, the compensation period P2, and the writing period P3, and may have an activation voltage level LVA in the bypass period P4 and the emission period P5. The third emission signal EM3 may have a deactivation voltage level LVD in the initialization period P1, the bypass period P4, and the emission period P5, and may have an activation voltage level LVA in the compensation period P2 and the writing period P3.

The activation voltage level LVA of each of the first emission signal EM1, the second emission signal EM2, and the third emission signal EM3 may be equal to the activation voltage level of the compensation gate signal GC, the activation voltage level of the bypass gate signal GB, and the activation voltage level of the write gate signal GW. The deactivation voltage level LVD of each of the first emission signal EM1, the second emission signal EM2, and the third emission signal EM3 may be equal to the deactivation voltage level of the compensation gate signal GC, the deactivation voltage level of the bypass gate signal GB, and the deactivation voltage level of the write gate signal GW.

The first bias voltage VEM1 may have a first activation voltage level LVA1 in the initialization period P1, the compensation period P2, the writing period P3, the bypass period P4, and the emission period P5, the second bias voltage VEM2 may have a second activation voltage level LVA2 in the initialization period P1, the compensation period P2, the writing period P3, the bypass period P4, and the emission period P5, and the third bias voltage VEM3 may have a deactivation voltage level LVD in the initialization period P1, the compensation period P2, the writing period P3, the bypass period P4, and the emission period P5. In an embodiment, each of the first bias voltage VEM1, the second bias voltage VEM2, and the third bias voltage VEM3 may be a constant voltage.

Each of the first activation voltage level LVA1 of the first bias voltage VEM1 and the second activation voltage level LVA2 of the second bias voltage VEM2 may be a logic low level, and the deactivation voltage level LVD of the third bias voltage VEM3 may be a logic high level. The first activation voltage level LVA1 of the first bias voltage VEM1 and the second activation voltage level LVA2 of the second bias voltage VEM2 may be different from the activation voltage level LVA of each of the first emission signal EM1, the second emission signal EM2, and the third emission signal EM3. In an embodiment, the first activation voltage level LVA1 of the first bias voltage VEM1 and the second activation voltage level LVA2 of the second bias voltage VEM2 may be higher than the activation voltage level LVA of each of the first emission signal EM1, the second emission signal EM2, and the third emission signal EM3.

The first activation voltage level LVA1 of the first bias voltage VEM1 and the second activation voltage level LVA2 of the second bias voltage VEM2 may be different from each other. FIG. 24 illustrates an embodiment in which the first activation voltage level LVA1 of the first bias voltage VEM1 is lower than the second activation voltage level LVA2 of the second bias voltage VEM2, however, the present disclosure is not limited thereto. In another embodiment, the first activation voltage level LVA1 of the first bias voltage VEM1 may be higher than the second activation voltage level LVA2 of the second bias voltage VEM2.

In an embodiment described with reference to FIGS. 22 to 24, a line that transmits the first bias voltage VEM1, a line that transmits the second bias voltage VEM2, and a line that transmits the third bias voltage VEM3 may be connected to the gate of the fourth transistor T4 through the seventh-first transistor T7-1, the seventh-second transistor T7-2, and the seventh-third transistor T7-3. Accordingly, a voltage drop of the bias voltage VEM1, VEM2, or VEM3 may be prevented, and voltage uniformity between pixels PX may be improved.

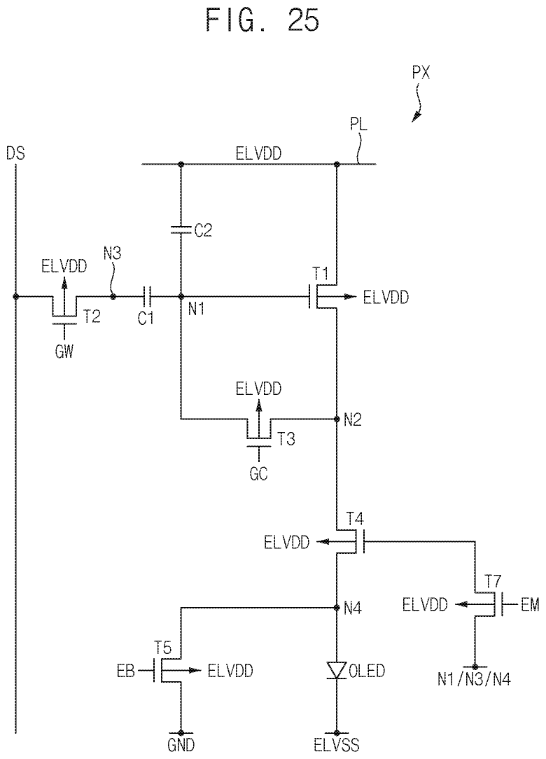

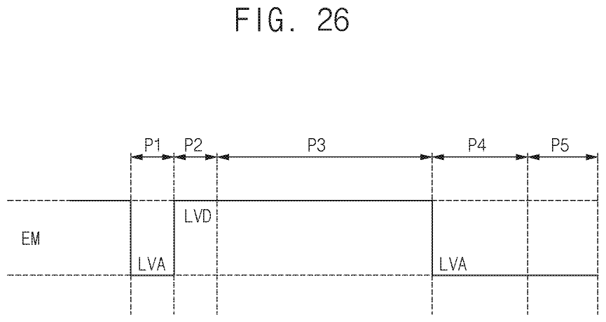

FIG. 25 is a circuit diagram illustrating an example of the pixel PX of FIG. 1. FIG. 26 is a timing diagram illustrating a signal EM of FIG. 25.

Referring to FIGS. 25 and 26, the pixel PX may include a first transistor T1, a second transistor T2, a first capacitor C1, a second capacitor C2, a third transistor T3, a fourth transistor T4, a fifth transistor T5, a seventh transistor T7, and a light-emitting element OLED. Descriptions of components of the pixel PX described with reference to FIGS. 25 and 26, which are substantially the same as or similar to those of the pixel PX described with reference to FIGS. 2 and 3, will be omitted.

The fourth transistor T4 may include a gate, a first terminal connected to the second node N2, and a second terminal connected to the fourth node N4.

The seventh transistor T7 may connect the first node N1, the third node N3, or the fourth node N4 to the gate of the fourth transistor T4 in response to the emission signal EM. The seventh transistor T7 may include a gate that receives the emission signal EM, a first terminal connected to the first node N1, the third node N3, or the fourth node N4, and a second terminal connected to the gate of the fourth transistor T4.

The emission signal EM may have an activation voltage level LVA in the initialization period P1, the bypass period P4, and the emission period P5, and may have a deactivation voltage level LVD in the compensation period P2 and the writing period P3. The activation voltage level LVA of the emission signal EM may be equal to the activation voltage level of the compensation gate signal GC, the activation voltage level of the bypass gate signal GB, and the activation voltage level of the write gate signal GW.

The first node N1, the third node N3, or the fourth node N4 may have an activation voltage level in the initialization period P1, the bypass period P4, and the emission period P5.

The activation voltage level of the first node N1, the third node N3, or the fourth node N4 may be a logic low level. The activation voltage level of the first node N1, the third node N3, or the fourth node N4 may be different from the activation voltage level LVA of the emission signal EM. In an embodiment, the activation voltage level of the first node N1, the third node N3, or the fourth node N4 may be higher than the activation voltage level LVA of the emission signal EM.

In an embodiment described with reference to FIGS. 25 and 26, the voltage of the first node N1, the third node N3, or the fourth node N4 in the pixel PX may be applied to the gate of the fourth transistor T4 without a voltage provided from outside the pixel PX.

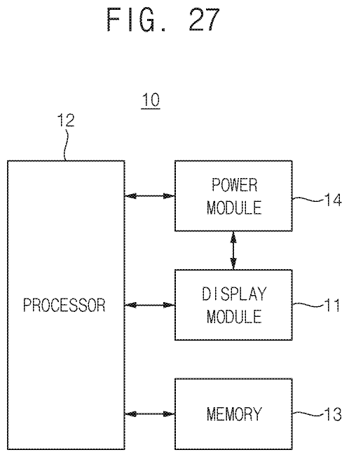

FIG. 27 is a block diagram illustrating an electronic device 10 according to an embodiment.

Referring to FIG. 27, the electronic device 10 may include a display module 11, a processor 12, a memory 13, and a power module 14.

The processor 12 may include at least one of a central processing unit (CPU), an application processor (AP), a graphic processing unit (GPU), a communication processor (CP), an image signal processor (ISP), and a controller.

The memory 13 may store data information necessary for an operation of the processor 12 or the display module 11. When the processor 12 executes an application stored in the memory 13, the input image data IMD1 of FIGS. 1, 11, 14, 17, and 22 and the control signal CNT0 of FIGS. 1, 11, 14, 17, and 22 may be transmitted to the display module 11, and the display module 11 may output image information based on the input image data IMD1 and the control signal CNT0.

The power module 14 may include a power supply module such as a power adapter, a battery device, etc. and a power conversion module that converts power supplied by the power supply module to generate power required for an operation of the electronic device 10.

At least one of the components of the electronic device 10 described above may be included in the display device 100 of FIG. 1, 101 of FIG. 11, 102 of FIG. 14, 103 of FIG. 17, or 104 of FIG. 22 according to the embodiments described above. Further, some of individual modules functionally included in one module may be included in the display device 100, 101, 102, 103, or 104, and others may be provided separately from the display device 100, 101, 102, 103, or 104. For example, the display device 100, 101, 102, 103, or 104 may include the display module 11, and the processor 12, the memory 13, and the power module 14 may be provided in the form of other devices within the electronic device 10 other than the display device 100, 101, 102, 103, or 104.

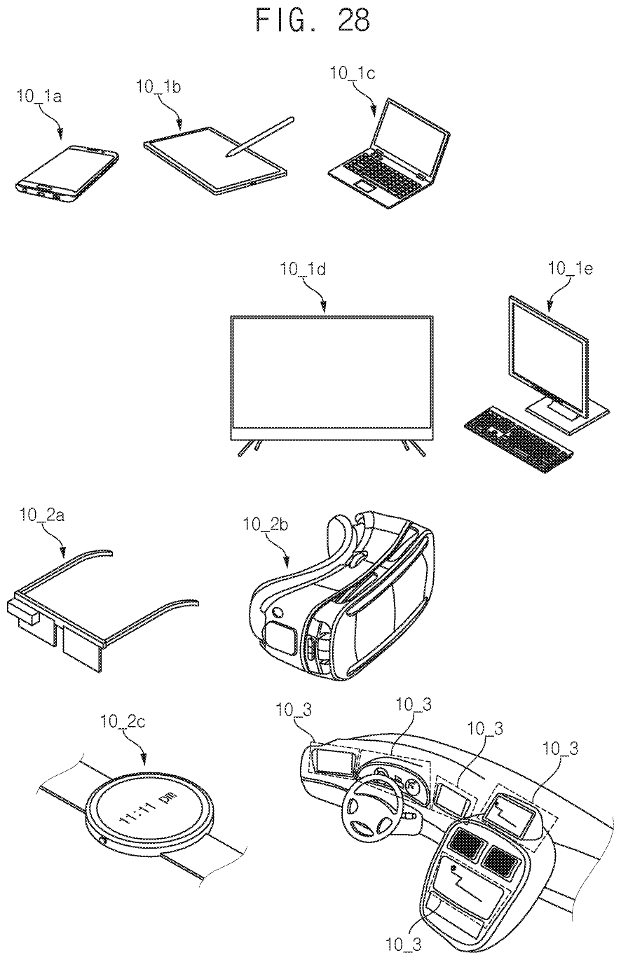

FIG. 28 is a diagram illustrating electronic devices according to embodiments.

Referring to FIG. 28, electronic devices to which display devices according to embodiments are applied may include not only image display electronic devices such as a smart phone 10_1a, a tablet PC 10_1b, a laptop 10_1c, a TV 10_1d, a desk monitor 10_1e, etc. but also wearable electronic devices including display modules such as smart glasses 10_2a, a head mounted display 10_2b, a smart watch 10_2c, etc., vehicle electronic devices 10_3 including display modules such as an instrument panel of an automobile, a center fascia, a center information display CID arranged on a dashboard, a room mirror display, etc.

The display device according to the embodiments may be applied to a display device included in a computer, a notebook, a mobile phone, a smart phone, a smart pad, a smart watch, a PMP, a PDA, an MP3 player, or the like.

Although the display device, the pixel, and the electronic device according to the embodiments have been described with reference to the drawings, the illustrated embodiments are examples, and may be modified and changed by a person having ordinary knowledge in the relevant technical field without departing from the technical spirit described in the following claims.

What is claimed is:

1. A display device, comprising:
a display panel comprising pixels;
a gate driver, which provides a write gate signal and a compensation gate signal to each of the pixels;
an emission driver, which provides an emission signal to each of the pixels; and
a data driver, which provides a data signal to each of the pixels,
wherein each of the pixels comprises:
a first transistor comprising a gate connected to a first node, a first terminal, which receives a first power voltage, and a second terminal connected to a second node;
a second transistor, which transmits the data signal to a third node in response to the write gate signal;
a first capacitor connected between the first node and the third node;
a third transistor, which connects the first node to the second node in response to the compensation gate signal;
a fourth transistor comprising a gate, a first terminal connected to the second node, and a second terminal connected to a fourth node; and
a light-emitting element comprising a first terminal connected to the fourth node, and a second terminal, which receives a second power voltage, and
wherein an activation voltage level of a signal received by the gate of the fourth transistor is different from an activation voltage level of the write gate signal.

2. The display device of claim 1, wherein a difference between the activation voltage level and a deactivation voltage level of the signal received by the gate of the fourth transistor is less than a difference between the activation voltage level and a deactivation voltage level of the write gate signal.

3. The display device of claim 1, wherein the activation voltage level of the signal received by the gate of the fourth transistor is higher than the activation voltage level of the write gate signal.

4. The display device of claim 1, wherein the activation voltage level of the signal received by the gate of the fourth transistor in an initialization period in which the gate of the first transistor is initialized is different from the activation voltage level of the signal received by the gate of the fourth transistor in an emission period in which the light-emitting element emits light.

5. The display device of claim 4, wherein a difference between the activation voltage level and a deactivation voltage level of the signal received by the gate of the fourth transistor in the initialization period is greater than a difference between the activation voltage level and the deactivation voltage level of the signal received by the gate of the fourth transistor in the emission period.

6. The display device of claim 4, wherein the activation voltage level of the signal received by the gate of the fourth transistor in the initialization period is lower than the activation voltage level of the signal received by the gate of the fourth transistor in the emission period.

7. The display device of claim 1, wherein a type of the first transistor is the same as a type of the fourth transistor.

8. The display device of claim 1, wherein each of the pixels further comprises:
a second capacitor connected between the first node and a power line, which transmits the first power voltage.

9. The display device of claim 1, wherein each of the pixels further comprises:
a fifth transistor, which transmits a ground voltage to the fourth node in response to a bypass gate signal.

10. The display device of claim 1, wherein the emission signal includes first and second emission signals,
wherein the gate of the fourth transistor receives the first emission signal, and
wherein each of the pixels further comprises a sixth transistor, which transmits the first power voltage to the first terminal of the first transistor in response to the second emission signal.

11. The display device of claim 1, wherein the gate of the fourth transistor receives the emission signal.

12. The display device of claim 11, wherein the pixels comprise a red pixel, a green pixel, and a blue pixel, and
wherein an activation voltage level of a red emission signal received by the gate of the fourth transistor of the red pixel, an activation voltage level of a green emission signal received by the gate of the fourth transistor of the green pixel, and an activation voltage level of a blue emission signal received by the gate of the fourth transistor of the blue pixel are different from each other.

13. The display device of claim 1, wherein the fourth transistor comprises:
a fourth-first transistor comprising a gate, which receives a bias voltage, a first terminal connected to the second node, and a second terminal; and
a fourth-second transistor comprising a gate, which receives the emission signal, a first terminal connected to the second terminal of the fourth-first transistor, and a second terminal connected to the fourth node.

14. The display device of claim 1, wherein the emission signal includes first to third emission signals,
wherein each of the pixels further comprises:
a seventh-first transistor comprising a gate, which receives the first emission signal, a first terminal, which receives a first bias voltage, and a second terminal connected to the gate of the fourth transistor;
a seventh-second transistor comprising a gate, which receives the second emission signal, a first terminal, which receives a second bias voltage, and a second terminal connected to the gate of the fourth transistor; and
a seventh-third transistor comprising a gate, which receives the third emission signal, a first terminal, which receives a third bias voltage, and a second terminal connected to the gate of the fourth transistor.

15. The display device of claim 1, wherein each of the pixels further comprises:
a seventh transistor comprising a gate, which receives the emission signal, a first terminal connected to the first node, the third node or the fourth node, and a second terminal connected to the gate of the fourth transistor.

16. A display device, comprising:
a display panel comprising pixels;
a gate driver, which provides a write gate signal to each of the pixels;
an emission driver, which provides a first emission signal and a second emission signal to each of the pixels; and
a data driver, which provides a data signal to each of the pixels,
wherein each of the pixels comprises:
a first transistor comprising a gate connected to a first node, a first terminal connected to a second node, and a second terminal connected to a third node;
a second transistor, which transmits the data signal to the first node in response to the write gate signal;
a first capacitor connected between the first node and the second node;
a fourth transistor, which connects the third node to a fourth node in response to the first emission signal;
a sixth transistor, which transmits a first power voltage to the second node in response to the second emission signal; and
a light-emitting element comprising a first terminal connected to the fourth node, and a second terminal, which receives a second power voltage, and
wherein an activation voltage level of the first emission signal is different from an activation voltage level of the write gate signal.

17. The display device of claim 16, wherein a difference between the activation voltage level and a deactivation voltage level of the first emission signal is less than a difference between the activation voltage level and a deactivation voltage level of the write gate signal.

18. The display device of claim 16, wherein the activation voltage level of the first emission signal is higher than the activation voltage level of the write gate signal.

19. The display device of claim 16, wherein each of the pixels further comprises:
a second capacitor connected between the second node and a power line, which transmits the first power voltage; and
a fifth transistor, which transmits a ground voltage to the fourth node in response to a bypass gate signal.

20. An electronic device, comprising:
a processor, which generates input image data;
a display device, which displays an image based on the input image data; and
a power module connected to the processor and the display device,
wherein the display device comprises:
a display panel comprising pixels;
a gate driver, which provides a write gate signal and a compensation gate signal to each of the pixels;
an emission driver, which provides an emission signal to each of the pixels; and
a data driver, which provides a data signal to each of the pixels, wherein each of the pixels comprises:
a first transistor comprising a gate connected to a first node, a first terminal, which receives a first power voltage, and a second terminal connected to a second node;
a second transistor, which transmits the data signal to a third node in response to the write gate signal;
a first capacitor connected between the first node and the third node;
a third transistor, which connects the first node to the second node in response to the compensation gate signal;
a fourth transistor comprising a gate, a first terminal connected to the second node, and a second terminal connected to a fourth node; and
a light-emitting element comprising a first terminal connected to the fourth node, and a second terminal, which receives a second power voltage, and
wherein an activation voltage level of a signal received by the gate of the fourth transistor is different from an activation voltage level of the write gate signal.
